(19) United States
(12) Patent Application Publication
(10) Pub. No.: US 2026/0003042 A1
(43) Pub. Date: Jan. 1, 2026

(54) DYNAMIC OUTPUT BIAS SIGNAL FOR A SINGLE PHOTON AVALANCHE DIODE (SPAD) BASED PHOTON DETECTION CIRCUIT

(71) Applicants: STMicroelectronics International N.V., Geneva (CH); University of Edinburgh, Edinburgh (GB)

(72) Inventors: Maciej WOJTKIEWICZ, Edinburgh (GB); Bruce RAE, Edinburgh (GB); Robert HENDERSON, Edinburgh (GB)

(21) Appl. No.: 18/755,197

(22) Filed: Jun. 26, 2024

(51) Int. Cl. G01S 7/4863; H04N 25/76

(52) U.S. Cl. CPC G01S 7/4863; H04N 25/76

(57) ABSTRACT

An example photon detection circuit, a SPAD sensing device, and a direct time-of-flight detection system comprising a SPAD sensing device configured to operate in a high illumination environments, are provided. The example photon detection circuit includes SPAD circuitry configured to generate a photon detection signal based on a SPAD bias voltage and the number of photons encountering the SPAD. The photon detection circuitry further includes output bias circuitry configured to generate a dynamic output bias signal, wherein the dynamic output bias signal is updated based on the number of photons encountering the SPAD. The example photon detection circuitry further includes output signal circuitry configured to generate a photon detection output signal in an instance in which the photon detection signal exceeds an output signal circuitry threshold, wherein the output signal circuitry threshold is based on the dynamic output bias signal.

### TECHNOLOGICAL FIELD

Embodiments of the present disclosure relate generally to single photon avalanche diode (SPAD) based photon detection circuits, and more particularly, to SPAD-based photon detection circuits operating in high illumination environments.

### BACKGROUND

A SPAD pixel generally utilizes a SPAD to detect and time photons with high timing precision. A SPAD is a solid state photodetector that uses a p-n junction to form a diode to enable the flow of current in an instance in which a particle of electromagnetic energy, such as a photon, encounters the p-n junction. A SPAD pixel is configured to output a voltage pulse in an instance in which one or more photons encounter the SPAD of the SPAD pixel.

Applicant has identified many technical challenges and difficulties associated with detecting photons at a SPAD pixel. Through applied effort, ingenuity, and innovation, Applicant has solved problems related to detecting photons at a SPAD pixel by developing solutions embodied in the present disclosure, which are described in detail below.

### BRIEF SUMMARY

Various embodiments are directed to an example photon detection circuit, a SPAD sensing device, and a direct time-of-flight detection system comprising a SPAD sensing device configured to operate in a high illumination environments.

An example photon detection circuit is provided. The example photon detection circuit comprises single photon avalanche diode (SPAD) circuitry configured to receive a SPAD bias voltage and generate a photon detection signal correlated with a number of photons encountering a SPAD and the SPAD bias voltage. The photon detection circuitry further includes output bias circuitry configured to generate a dynamic output bias signal, wherein the dynamic output bias signal is updated based on the number of photons encountering the SPAD. The example photon detection circuitry further includes output signal circuitry configured to generate a photon detection output signal in an instance in which the photon detection signal exceeds an output signal circuitry threshold, wherein the output signal circuitry threshold is based on the dynamic output bias signal.

In some embodiments, a saturation of the SPAD is determined based on a photon event rate, and wherein the photon event rate corresponds to a number of photons encountering the SPAD in a time period.

In some embodiments, the dynamic output bias signal is reduced in an instance in which the saturation of the SPAD increases.

In some embodiments, the dynamic output bias signal is increased in an instance in which the saturation of the SPAD decreases.

In some embodiments, the SPAD bias voltage is adjusted based on the saturation of the SPAD.

In some embodiments, the SPAD bias voltage is shifted towards a breakdown voltage of the SPAD in an instance in which the saturation of the SPAD increases.

In some embodiments, the dynamic output bias signal is updated within a dynamic output bias signal range comprising a minimum dynamic output bias signal voltage equal to the output signal circuitry threshold, and a maximum dynamic output bias signal voltage equal to a source voltage of the photon detection circuit.

In some embodiments, the SPAD circuitry comprises a SPAD comprising an anode electrically connected to an electrical ground and a cathode. The SPAD circuitry further comprises a quenching resistor comprising a first resistor terminal electrically connected to the SPAD bias voltage and a second resistor terminal electrically connected to the cathode of the SPAD. The SPAD circuitry further comprises a capacitor comprising a first capacitor terminal electrically connected to the cathode of the SPAD and a second capacitor terminal configured to generate the photon detection signal.

In some embodiments, the output bias circuitry comprises a pull-up transistor comprising a source terminal electrically connected to the dynamic output bias signal; a drain terminal electrically connected to an input of the output signal circuitry; and a gate terminal electrically connected to a dynamic bias enable voltage.

In some embodiments, the output signal circuitry comprises a first inverter and a second inverter, wherein the output signal circuitry threshold is a threshold voltage of the first inverter.

In some embodiments, the first inverter comprises a first front inverter transistor and a second front inverter transistor, and the second inverter comprises a first back inverter transistor and a second back inverter transistor.

In some embodiments, the first front inverter transistor and the second front inverter transistor are double gate oxide devices.

In some embodiments, the first back inverter transistor and the second back inverter transistor are single gate oxide devices.

In some embodiments, the first front inverter transistor is a PMOS transistor, and the second front inverter transistor is a diode connected PMOS transistor.

In some embodiments, the second front inverter transistor is an NMOS transistor, and the first front inverter transistor is a diode connected NMOS transistor.

In some embodiments, the photon detection circuitry further comprises a first layer comprising a top surface exposed to an external environment and a second layer adjacent a bottom surface of the first layer, opposite the top surface. In some embodiments, the SPAD circuitry is disposed on the first layer of the photon detection circuit, and the output bias circuitry and output signal circuitry are disposed on the second layer of the photon detection circuitry.

An example SPAD sensing device configured to generate an image histogram is also provided. The example SPAD sensing device comprising a SPAD pixel array comprising a plurality of photon detection circuits arranged in a two-dimensional shape comprising rows and columns. Each photon detection circuit in the SPAD pixel array comprising single photon avalanche diode (SPAD) circuitry, output bias circuitry, and output signal circuitry. The SPAD circuitry configured to receive a SPAD bias voltage and generate a photon detection signal correlated with a number of photons encountering a SPAD and the SPAD bias voltage. The output bias circuitry configured to generate a dynamic output bias signal, wherein the dynamic output bias signal is updated based on the number of photons encountering the SPAD. The output signal circuitry configured to generate a photon detection output signal in an instance in which the photon detection signal exceeds an output signal circuitry threshold. In some embodiments, the output signal circuitry threshold is based on the dynamic output bias signal.

In some embodiments, a saturation of the SPAD is determined based on a photon event rate, wherein the photon event rate corresponds to a number of photons encountering the SPAD in a time period, and wherein the dynamic output bias signal is adjusted based on the saturation of the SPAD.

An example direct time-of-flight detection system is further provided. In some embodiments, the example direct time-of-flight detection system comprises a light source, and a SPAD sensing device. The light source is configured to transmit optical radiation directed at a target object. The SPAD sensing device is configured to receive reflected optical radiation reflected off the target object. The SPAD sensing device comprising a SPAD pixel array comprising a plurality of photon detection circuits arranged in a two-dimensional shape comprising rows and columns. Each photon detection circuit in the SPAD pixel array comprising single photon avalanche diode (SPAD) circuitry, output bias circuitry, and output signal circuitry. The SPAD circuitry configured to receive a SPAD bias voltage and generate a photon detection signal correlated with a number of photons encountering a SPAD and the SPAD bias voltage. The output bias circuitry configured to generate a dynamic output bias signal, wherein the dynamic output bias signal is updated based on the number of photons encountering the SPAD. The output signal circuitry configured to generate a photon detection output signal in an instance in which the photon detection signal exceeds an output signal circuitry threshold. In some embodiments, the output signal circuitry threshold is based on the dynamic output bias signal.

In some embodiments, a saturation of the SPAD is determined based on a photon event rate, wherein the photon event rate corresponds to a number of photons encountering the SPAD in a time period, and wherein the dynamic output bias signal is adjusted based on the saturation of the SPAD.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a block diagram of an example photon detection circuit in accordance with an example embodiment of the present disclosure.

FIG. 2 illustrates a circuit-level diagram of an example embodiment of a photon detection circuit in accordance with an example embodiment of the present disclosure.

FIG. 3 illustrates a circuit-level diagram of an example photon detection circuit comprising a diode-connected p-channel metal-oxide semiconductor (PMOS) transistor in accordance with an example embodiment of the present disclosure.

FIG. 4 illustrates a circuit-level diagram of an example photon detection circuit comprising a diode-connected n-channel metal-oxide semiconductor (NMOS) transistor in accordance with an example embodiment of the present disclosure.

FIG. 5 depicts a block diagram of an example SPAD sensing device in accordance with an example embodiment of the present disclosure.

FIG. 6 illustrates a block diagram of an example direct time-of-flight detection system in accordance with an example embodiment of the present disclosure.

FIG. 7 provides a graph illustrating the photon event rate at various dynamic output bias signal voltages with respect to an irradiance in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with detection of photons at a SPAD pixel (e.g., photon detection circuit) operating in potentially high illumination conditions. As understood by those of skill in the field to which the present disclosure pertains, there are numerous operating scenarios in which a SPAD pixel may be exposed to high illumination conditions.

In general, a SPAD pixel utilizes a SPAD to detect and time single photons with high timing precision. A SPAD is a solid state photodetector that utilizes a p-n junction to form a diode to enable the flow of current in an instance in which a particle of electromagnetic energy, such as a photon, encounters the p-n junction. For example, a SPAD may be biased at an operating voltage that exceeds the breakdown voltage of the SPAD. However, the SPAD may be devoid of charge carriers. In such a state, the electric field is so high, that a single charge carrier (e.g., photon) encountering the SPAD can trigger an avalanche condition (e.g., impact ionization) in which many charge carriers are released leading to a rapid rise in current. The rapid rise in current may generate an output pulse from the SPAD pixel.

A SPAD pixel may typically include a SPAD, a quenching resistor, a coupling capacitor, a pull-up transistor, and an output inverter. As described above, the SPAD generates an avalanche current in an instance in which a photon interacts with the SPAD. The avalanche current is converted into a voltage pulse and coupled to the output inverter through the coupling capacitor. In an instance in which the voltage pulse exceeds the threshold of the output inverter, an output signal is generated, indicating the arrival of one or more photons. In addition, the quenching resistor is configured to quench the avalanche current by lowering the voltage at the SPAD back to the bias voltage.

A SPAD sensing device may include a plurality of SPAD pixels configured in a SPAD pixel array. A SPAD sensing device may be utilized in various applications. For example, a SPAD sensing device may be configured to detect and time reflected optical radiation from a light source as part of a direct time-of-flight detection system. The high precision time associated with the reception of reflected optical radiation may enable a direct time-of-flight detection system to accurately identify the distance to a target object.

In some configurations, a SPAD pixel may operate in a high illumination environment. SPAD pixels can easily saturate in such environments. SPAD pixel saturation is especially prevalent in LiDAR systems where the SPAD sensor may be exposed to a high solar background (e.g., outdoor), or, for example, in an instance in which the SPAD pixels are subjected to solar reflections from different objects nearby possibly blinding the pixels. When there is an abundance of photons the SPAD pixel avalanches so frequently that there may not be enough time to fully recharge to the bias voltage of the SPAD. In an instance in which the SPAD device is unable to fully recharge, the voltage signal transmitted by the coupling capacitor decreases in amplitude, even as the photon rate increases. Small amplitude output pulses are no longer sufficient to exceed the threshold of the inverter. In such an instance, the pixel count rate falls to zero, even when the SPAD device is still reacting to the incoming photons.

In some examples, SPAD pixels have implemented a comparator in order to detect very small amplitude output pulses that may occur in high illumination environments. However, comparators occupy significant area and consume significant power. Thus, providing a compact and low power SPAD pixel may be difficult using comparators. In other examples, the size of the SPAD or the density SPADs in a SPAD array is decreased to reduce the amount of incident photons which encounter the SPAD. However, reducing the size of the SPAD is a difficult process and may result in a poor performing SPAD.

The various example embodiments described herein describe a photon detection circuit (e.g., SPAD pixel) which utilizes a dynamic output bias signal provided to the output signal circuitry (e.g., output inverter) based on the saturation level of the SPAD device. A dynamic bias output signal based on the saturation level of the SPAD device may effectively alter the output signal circuitry threshold based on the amount of light received at the SPAD. Thus, the photon detection circuit may transition from a high sensitivity mode in an instance in which the illumination level of the environment is low, to a low sensitivity mode in an instance in which the illumination level of the environment is high.

Further, in some embodiments, the photon detection circuit of the present disclosure may adjust the SPAD bias voltage in coordination with the dynamic output bias signal based on the saturation of the SPAD. For example, the SPAD bias voltage may determine the bias voltage relative to the breakdown voltage of the SPAD. In an instance in which the illumination level of the environment is low, the SPAD bias voltage may be pushed far beyond the breakdown voltage such that the amplitude of the avalanche current is increased. Conversely, in an instance in which the illumination level of the environment is high, the SPAD bias voltage may be kept closer to the breakdown voltage such that more photons may be required to cause impact ionization.

As further described herein, in some example embodiments, the size and configuration of the electrical components comprising the output signal circuitry may be adjusted based on the performance of the photon detection circuit utilizing the dynamic output bias signal. For example, in some embodiments, the use of a dynamic output bias signal and SPAD bias voltage may enable the use of all single gate transistors (e.g., thin oxide transistors) in the output signal circuitry, even in high voltage applications. Because the variation in amplitude of the voltage received at each of the electrical components interfacing with the SPAD may be limited, the dynamic output bias signal may prevent voltage differences exceeding the voltage ratings of the interfacing electrical components. In addition, various other embodiments which may provide area and power savings may be implemented.

As a result of the herein described example embodiments and in some examples, the operation of a photon detection circuit in high illumination environments may be greatly improved. In addition, the photon detection circuit may be configured to operate within strict area and power requirements.

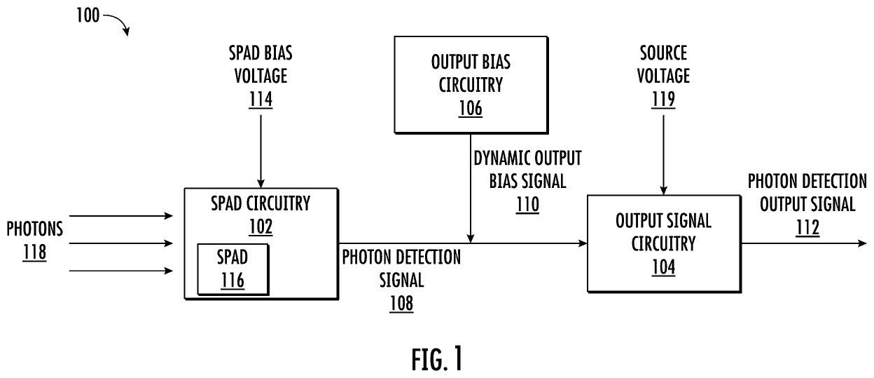

Referring now to FIG. 1, a block diagram of an example photon detection circuit 100 is provided. As depicted in FIG. 1, the example photon detection circuit 100 includes SPAD circuitry 102 comprising a SPAD 116 and configured to receive photons 118 and generate a photon detection signal based on a SPAD bias voltage. As further depicted in FIG. 1, the example photon detection circuit 100 includes output signal circuitry 104 configured to generate a photon detection output signal 112 based on the amplitude of the photon detection signal 108. The output signal circuitry 104 is further configured to receive a source voltage 119 and the dynamic output bias signal 110.

As depicted in FIG. 1, the example photon detection circuit 100 includes SPAD circuitry 102. SPAD circuitry 102 is any circuitry including hardware and/or software comprising a SPAD 116 and configured to generate a photon detection signal 108 with varying electrical properties (e.g., current, voltage) based on the number of photons 118 received at the SPAD 116.

A SPAD 116 is a solid state photodetector that utilizes a p-n junction to form a diode to enable the flow of current in an instance in which a particle of electromagnetic energy, such as a photon 118, encounters the SPAD 116. A SPAD 116 is reverse biased with a SPAD bias voltage 114 higher than a breakdown voltage of the SPAD 116 and devoid of charge carriers, creating a high electric field. Due to the high electric field, in an instance in which a photon 118 hits the SPAD 116 an avalanche condition (e.g., impact ionization) is triggered. The avalanche condition generates a short, high current pulse on the photon detection signal 108.

The performance of the SPAD 116 is dependent upon the SPAD bias voltage 114. The SPAD bias voltage 114 is any electromagnetic signal transmitted to the SPAD circuitry 102 to control the excess bias voltage at the SPAD 116. The excess bias voltage is the difference between the SPAD bias voltage 114 and the breakdown voltage of the SPAD 116. The SPAD bias voltage 114, and thus, the excess bias voltage may determine the sensitivity of the SPAD 116. For example, in high illumination environments, the sensitivity of the SPAD 116 may be decreased by shifting the SPAD bias voltage 114 nearer to the breakdown voltage of the SPAD 116. In such a low sensitivity mode, the current peaks triggered by incoming photons 118 may be minimized. Conversely, in low illumination environments, the sensitivity of the SPAD 116 may be increased by shifting the SPAD bias voltage 114 further past the breakdown voltage of the SPAD 116. In such a high sensitivity mode, the current peaks triggered by incoming photons 118 may be increased.

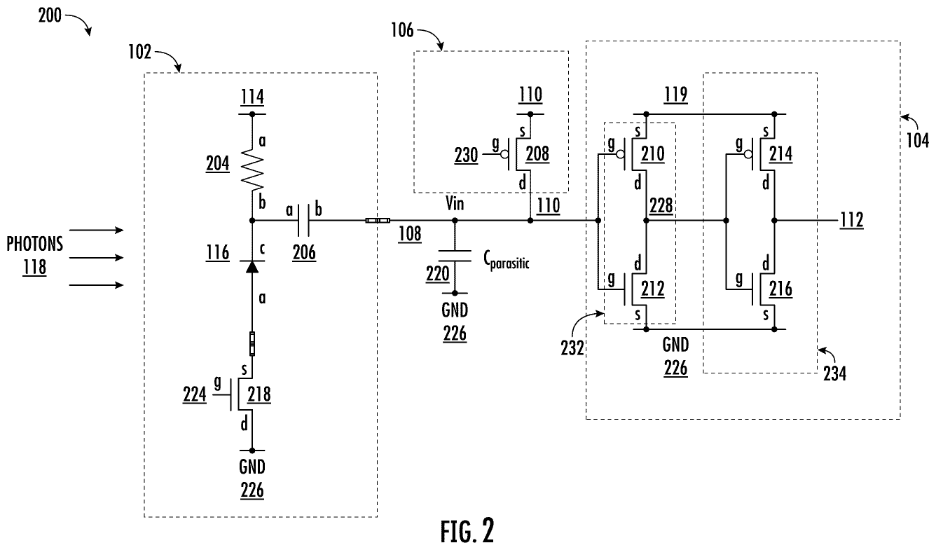

As further depicted in FIG. 1, the SPAD circuitry 102 is further configured to generate a photon detection signal 108. The photon detection signal 108 is generated based on the number of photons 118 encountering the SPAD, and the SPAD bias voltage 114. As described herein, due to the high electric field in the SPAD 116, in an instance in which a photon 118 hits the SPAD 116 an avalanche condition (e.g., impact ionization) is triggered. The avalanche condition generates a short, high current pulse which may be output as the photon detection signal 108. In some embodiments, the SPAD circuitry 102 may include an resistor-capacitor (RC) circuit to continually charge a capacitor and output a signal pulse based on the reception of one or more photons 118 at the SPAD 116. In such an example, the photon detection signal 108 may represent a direct current (DC) component of the electrical signal generated by the SPAD 116. Example embodiments of SPAD circuitry 102 are shown in FIG. 2-FIG. 4.

As further depicted in FIG. 1, the example photon detection circuit 100 includes output signal circuitry 104. The output signal circuitry 104 is any circuitry including hardware and/or software configured to output a source voltage 119 pulse in an instance in which the photon detection signal 108 exceeds an output signal circuitry threshold. The output signal circuitry threshold defines the minimum electrical characteristic (e.g., current, voltage) an input signal (e.g., photon detection signal 108) must exceed, before the source voltage 119 is output on the photon detection output signal 112. The output signal circuitry threshold may be defined based on the internal components of the output signal circuitry 104. For example, in an instance in which the output signal circuitry 104 includes one or more inverters comprising transistors, the output signal circuitry threshold may be defined by the threshold voltage of one or more transistors comprising the inverters.

The output signal circuitry threshold may further be defined by an input bias voltage (e.g., dynamic output bias signal 110). As depicted in FIG. 1, the example photon detection circuit 100 includes output bias circuitry 106. Output bias circuitry 106 is any circuitry including hardware and/or software configured to provide a dynamic output bias signal 110 to the output signal circuitry 104. The dynamic output bias signal 110 is any electromagnetic signal provided to the output signal circuitry 104 altering the output signal circuitry threshold of the output signal circuitry 104. By altering the output signal circuitry threshold, the dynamic output bias signal 110 may alter the overall sensitivity of the output signal circuitry 104. The dynamic output bias signal 110 may be updated within a dynamic output bias signal range having a minimum dynamic output bias signal voltage and a maximum dynamic output bias signal voltage.

For example, in some embodiments, the minimum dynamic output bias signal voltage may be at or near the output signal circuitry threshold. By adjusting the dynamic output bias signal 110 near the output signal circuitry threshold, the output signal circuitry 104 may operate in a low sensitivity mode. In a low sensitivity mode, the photon detection output signal 112 may output a pulse equivalent to the source voltage 119 at a lower voltage threshold compared to the high sensitivity mode. Thus, the voltage amplitude of the photon detection signal 108 may be smaller, relative to the high sensitivity mode, to trigger a measurable output on the photon detection output signal 112. Conversely, in some embodiments, the maximum dynamic output bias signal voltage may be at or near the source voltage. By adjusting the dynamic output bias signal 110 at or near the source voltage, the output signal circuitry 104 may operate in a high sensitivity mode. In a high sensitivity mode, the photon detection output signal 112 may output a pulse equivalent to the source voltage 119 at a higher threshold. Thus, the voltage amplitude of the photon detection signal 108 must be larger, relative to the low sensitivity mode, to trigger a measurable output on the photon detection output signal 112.

As described herein, the photon detection circuit 100 may become fully saturated easily in high illumination conditions. Full saturation occurs in an instance in which the SPAD 116 receives photons 118 at such a high rate that the SPAD circuitry 102 is unable to fully recharge between triggering avalanches. In such an instance, the output voltage of the photon detection signal 108 is reduced. In some instances during high illumination conditions, the peak voltages of the photon detection signal 108 are below the output signal circuitry threshold of the output signal circuitry 104. Thus, the avalanche pulses generated by the SPAD circuitry 102 do not cause a pulse at the photon detection output signal 112. In some instances, the photon detection circuit 100 may enter a state of paralysis in which the SPAD 116 is continually receiving photons 118 and outputting pulses but the voltage of the pulses is not enough to trigger a pulse on the photon detection output signal 112. Thus, the SPAD 116 continually avalanches but no photons 118 are indicated by the photon detection output signal 112.

As described herein, the dynamic output bias signal 110 provided by the dynamic output bias circuitry 106 alters the output signal circuitry threshold of the output signal circuitry 104. In an instance in which the SPAD 116 is exposed to a high illumination environment the dynamic output bias signal 110 is adjusted to increase the sensitivity of the output signal circuitry 104. Increasing the sensitivity of the output signal circuitry 104 enables generation of a pulse on the photon detection output signal 112 at low voltage pulses on the photon detection signal 108, compared to a low sensitivity mode.

The output bias circuitry 106 may utilize various mechanisms to determine the saturation level of the SPAD 116. For example, the output bias circuitry 106 may utilize a processor to monitor the number of photons 118 encountering one or more SPADs, and/or determine a photon event rate (e.g., the number of photons in a given time period) to impact one or more SPADs. In some embodiments, the output bias circuitry 1067 may determine a SPAD 116 is at or near full saturation in an instance in which the illuminance of the environment is increasing but the change in photon event rate is slowing, leveling off, or even declining.

As further described herein, the SPAD bias voltage 114 may alter the sensitivity of the SPAD 116. For example, the SPAD bias voltage 114 may also be updated based on the saturation level of the SPAD 116 and/or the number of photons encountering the SPAD 116. Thus, the SPAD bias voltage 114 may be updated in coordination with the dynamic output bias signal 110 to change the overall sensitivity of the photon detection circuit 100. For example, the SPAD bias voltage 114 may be moved farther past the breakdown voltage of the SPAD 116 in a high sensitivity mode to increase the amplitude of the voltage peaks of the photon detection signal 108. Conversely, the SPAD bias voltage 114 may be moved closer to the breakdown voltage of the SPAD 116 in a low sensitivity mode to decrease the amplitude of the voltage peaks of the photon detection signal 108

Referring now to FIG. 2, an example circuit diagram of an example embodiment of a photon detection circuit 200 is provided. As depicted in FIG. 2, the example photon detection circuit 200 includes output signal circuitry 104 electrically connected to SPAD circuitry 102 and further configured to receive a dynamic output bias signal 110 from output bias circuitry 106.

As further depicted in FIG. 2, the SPAD circuitry 102 includes a SPAD 116 having a cathode terminal 116c and an anode terminal 116a; a quenching resistor 204 having a first terminal 204a and a second terminal 204b; a capacitor 206 having a first terminal 206a and a second terminal 206b; and a transistor 218 having a source terminal 218s, a gate terminal 218g, and a drain terminal 218d. As depicted in FIG. 2, the cathode terminal 116c of the SPAD 116 is electrically connected to the second terminal 204b of the quenching resistor 204 and the first terminal 206a of the capacitor 206. In addition, the anode terminal 116a of the SPAD 116 is electrically connected to the source terminal 218s of the transistor 218. The gate terminal 218g of the transistor 218 is further connected to a SPAD enable voltage 224 with the drain terminal 218d electrically connected to an electrical ground 226. The first terminal 204a of the quenching resistor 204 is electrically connected to the SPAD bias voltage 114. Further, the second terminal 206b of the capacitor 206 is electrically connected to the output signal circuitry 104, and the electrical signal at the second terminal 206b of the capacitor 206 is the photon detection signal 108. As depicted in FIG. 2, the example transistor 218 is a p-channel metal-oxide semiconductor (PMOS) transistor.

As further depicted in FIG. 2, a parasitic capacitance 220 is generated between the second terminal 206b of the capacitor 206 and the electrical ground 226.

As further depicted in FIG. 2, the example output bias circuitry 106 includes a pullup transistor 208 comprising a source terminal 208s, a gate terminal 208g, and a drain terminal 208d. The gate terminal 208g of the pullup transistor 208 is electrically connected to a pullup transistor enable voltage 230. The source terminal 208s of the pullup transistor 208 is electrically connected to the dynamic output bias signal 110. Further, the drain terminal 208d of the pullup transistor 208 is electrically connected to the second terminal 206b of the capacitor 206 and to the output signal circuitry 104. In an instance in which the pullup transistor 208 is enabled based on the pullup transistor enable voltage 230 the dynamic output bias signal 110 is transmitted to the output signal circuitry 104. The example pullup transistor 208 depicted in FIG. 2 is an n-channel metal-oxide semiconductor (NMOS) transistor.

As further depicted in FIG. 2, the output signal circuitry 104 includes a first inverter 232 (e.g., front inverter) connected in series with a second inverter 234 (e.g., back inverter). The output signal circuitry 104 is configured to receive the photon detection signal 108 and the dynamic output bias signal 110 at the first inverter 232 and output the photon detection output signal 112 at the second inverter 234.

The first inverter 232 includes a first front inverter transistor 210 and a second front inverter transistor 212 connected in a standard inverter configuration. The first front inverter transistor 210 is a PMOS transistor with a source terminal 210s electrically connected to the source voltage 119. The second front inverter transistor 212 is an NMOS transistor with a source terminal 212s electrically connected to the electrical ground 226. The gate terminals 210g, 212g of both transistors 210, 212 are electrically connected to the second terminal 206b of the capacitor 206 and the drain terminal 208d of the pullup transistor 208 and configured to receive the photon detection signal 108 and the dynamic output bias signal 110. The drain terminals 210d, 212d of both transistors 210, 212 are electrically connected to generate the first inverter output 228.

The second inverter 234 includes a first back inverter transistor 214 and a second back inverter transistor 216 connected in a standard inverter configuration. The first back inverter transistor 214 is a PMOS transistor with a source terminal 214s electrically connected to the source voltage 119. The second back inverter transistor 216 is an NMOS transistor with a source terminal 216s electrically connected to the electrical ground 226. The gate terminals 214g, 216g of both transistors 214, 216 are electrically connected to the drain terminals 210d, 212d of the front inverter transistors, and configured to receive the first inverter output 228. The drain terminals 214d, 216d of both transistors 214, 216 are electrically connected to generate the photon detection output signal 112.

As depicted in FIG. 2, the output signal circuitry threshold is defined by the transistors of the first inverter 232 (e.g., first front inverter transistor 210, second front inverter transistor 212). In an instance in which the input voltage at the gate of the first front inverter transistor 210 is below the threshold voltage of the first front inverter transistor 210, the first front inverter transistor 210 is enabled, and the source voltage 119 is transmitted to the first inverter output 228. If the threshold voltage of the first front inverter transistor 210 is at or near the threshold voltage of the second front inverter transistor 212, the second front inverter transistor 212 is disabled at the same input voltage. Conversely, in an instance in which the input voltage at the gate of the first front inverter transistor 210 is above the threshold voltage of the first front inverter transistor 210, the first front inverter transistor 210 is disabled and the second front inverter transistor 212 is enabled. Thus, the first inverter output 228 is electrically connected to the electrical ground 226 and the first inverter output 228 is brought low.

The second inverter 234 inverts the first inverter output 228. Thus, in an instance in which the input voltage to the first inverter 232 exceeds the output signal circuitry threshold, a logic high equivalent to the source voltage 119 is output as the photon detection output signal 112. In an instance in which the input voltage to the first inverter 232 is below the output signal circuitry threshold, a logic low equivalent to the electrical ground is output as the photon detection output signal 112.

As described herein, the dynamic output bias signal 110 may be adjusted based on the number of photons 118 received at the SPAD 116 and/or the saturation of the SPAD 116. Additional circuitry and/or processors not pictured may determine the amplitude of the output bias circuitry 106 based on the number of photons 118 received at the SPAD 116. For example, in high illumination conditions in which the number of photons 118 received at the SPAD 116 is high. As the SPAD 116 approaches saturation, the amplitude of the photon detection signal 108 is reduced due to the rapidly occurring avalanche events of the SPAD 116. The dynamic output bias signal 110 may be adjusted to reduce the output signal circuitry threshold of the output signal circuitry 104 (e.g., the first inverter 232). Reducing the output signal circuitry threshold may enable the voltage peaks of the photon detection signal 108 indicating the reception of photons 118, to be detected. Similarly, in a low illumination or normal illumination condition, in which the number of photons 118 received at the SPAD 116 is low, the dynamic output bias signal 110 may be adjusted to increase the output signal circuitry threshold of the output signal circuitry 104 (e.g., the first inverter 232). Increasing the output signal circuitry threshold may prevent false detections during normal or low illumination conditions in which the voltage peaks of the photon detection signal 108 are magnified.

In some embodiments, the physical characteristics of the transistors (e.g., first front inverter transistor 210, second front inverter transistor 212, first back inverter transistor 214, second back inverter transistor 216) may be altered to change the output signal circuitry threshold and/or enable design of physically smaller photon detection circuits 200.

A number of dimensions determine the threshold voltage of a transistor. For example, the length and width of a gate comprising a transistor may determine the threshold voltage of the transistor. The dimensions of the transistors comprising the first inverter 232 may be adjusted to facilitate efficient and effective operation of the photon detection circuit 200. For example, the length and width of the transistors may be adjusted to lower the overall threshold voltage of the first inverter 232. In this way, the threshold voltage of the first inverter 232 may be lowered without consumption of excess power based on the dynamic output bias signal 110. In this way, the overall sensitivity of the photon detection circuit 200 is increased. A lower output signal circuitry threshold may be enabled by the use of a dynamic output bias signal 110, and in some embodiments, a dynamic SPAD bias voltage 114.

Further, the dimensions of the pair of transistors comprising an inverter (e.g., first front inverter transistor 210 and second front inverter transistor 212, or first back inverter transistor 214, second back inverter transistor 216) may be adjusted to separate the threshold voltage of the two sides of the inverter. In some examples, the threshold voltage of the first transistor and the second transistor of an inverter are designed to match. However, in an instance in which the input voltage is near the threshold voltage both inverters may be turned on, causing current to flow from the source voltage 119 through to the inverter to the electrical ground 226. Thus, the dimensions of the transistor pair may be altered to separate the threshold voltage of the transistors in the pair of transistors. For example, the width of the gate of the first front inverter transistor 210 may be widened and/or the gate of the second front inverter transistor 212 narrowed such that the gate of the first front inverter transistor 210 is wider than the gate of the second front inverter transistor 212. In some examples, the gate of the first front inverter transistor 210 may be greater than 1.5 times wider than the gate of the second front inverter transistor 212. In such an embodiment, the threshold voltage of the first front inverter transistor 210 is lowered, while the threshold voltage of the second front inverter transistor 212 is raised.

In addition, the gate oxide thickness may determine the voltage rating of a given transistor. For example, a thicker gate oxide may enable a higher voltage rating. The voltage rating of a transistor may determine the magnitude of the voltage difference that may be present between any two terminals of the transistor before the transistor is susceptible to damage. An increased voltage rating may enable the use of high voltage signals throughout an electronic system. However, a transistor with a high voltage rating may require a thick oxide, or double gate oxide, occupying more space within the integrated circuit. A double gate oxide transistor may be referred to as a thick gate oxide or double gate oxide transistor. A double gate oxide transistor may utilize an oxide layer between the gate semiconductor and the channel region that is larger in comparison to a single gate oxide transistor (e.g., thin oxide transistor, standard transistor). For example, in some embodiments, a single gate oxide transistor may comprise an oxide layer at the gate less than or equal to 1.25 nanometers. A double gate oxide transistor may have a gate oxide layer that is greater than 1.25 nanometers.

In some embodiments, all transistors interacting with the photon detection signal 108 (e.g., first front inverter transistor 210, second front inverter transistor 212, pullup transistor 208) may comprise double gate oxide transistors. Such an architecture enables the transistors interacting with the photon detection signal 108 to withstand large voltages output by the SPAD 116. However, double gate oxide transistors are bulky and may perform poorly at high frequencies. By controlling the output signal circuitry threshold based on the number of photons received at a SPAD 116, the SPAD bias voltage 114 may also be adjusted according to the number of photons received at the SPAD 116 such that the variability of the photon detection signal 108 is minimized. Minimizing the amplitude range of the photon detection signal 108 enables the use of single gate oxide transistors throughout the photon detection circuit 200. For example, the first front inverter transistor 210, the second front inverter transistor 212, the pullup transistor 208, the first back inverter transistor 214, and the second back inverter transistor 216 may all comprise single gate oxide transistors.

In some embodiments, the photon detection circuit 100 may comprise a layered integrated circuit (IC) architecture. In such an embodiment, the SPAD circuitry 102 comprising the SPAD 116 may comprise the topmost or outer most layer of the layered IC architecture, thus, maximizing the exposure of the SPAD circuitry 102 to photons 118 in an external environment. All other circuitry, including output bias circuitry 106 and output signal circuitry 104 may be included on layers of the layered IC architecture below the SPAD circuitry 102. In some embodiments, the transistor 218 may further be included on layers of the layered IC architecture below the SPAD circuitry 102.

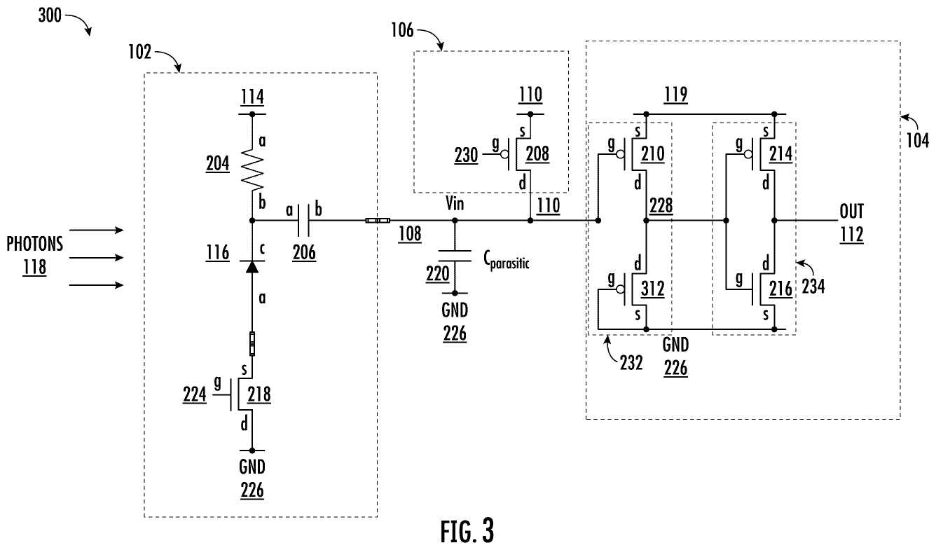

Referring now to FIG. 3, an example photon detection circuit 300 in accordance with the present disclosure, is provided. As depicted in FIG. 3, the example photon detection circuit 300 includes output signal circuitry 104 electrically connected to SPAD circuitry 102 and further configured to receive a dynamic output bias signal 110 from output bias circuitry 106.

As further depicted in FIG. 3, the SPAD circuitry 102 includes a SPAD 116 having a cathode terminal 116c and an anode terminal 116a; a quenching resistor 204 having a first terminal 204a and a second terminal 204b; a capacitor 206 having a first terminal 206a and a second terminal 206b; and a transistor 218 having a source terminal 218s, a gate terminal 218g, and a drain terminal 218d. As depicted in FIG. 3, the cathode terminal 116c of the SPAD 116 is electrically connected to the second terminal 204b of the quenching resistor 204 and the first terminal 206a of the capacitor 206. In addition, the anode terminal 116a of the SPAD 116 is electrically connected to the source terminal 218s of the transistor 218. The gate terminal 218g of the transistor 218 is further connected to a SPAD enable voltage 224 with the drain terminal 218d electrically connected to an electrical ground 226. The first terminal 204a of the quenching resistor 204 is electrically connected to the SPAD bias voltage 114. Further, the second terminal 206b of the capacitor 206 is electrically connected to the output signal circuitry 104, and the electrical signal at the second terminal 206b of the capacitor 206 is the photon detection signal 108. As depicted in FIG. 3, the example transistor 218 is a p-channel metal-oxide semiconductor (PMOS) transistor.

As further depicted in FIG. 3, a parasitic capacitance 220 is generated between the second terminal 206b of the capacitor 206 and the electrical ground 226.

As further depicted in FIG. 3, the example output bias circuitry 106 includes a pullup transistor 208 comprising a source terminal 208s, a gate terminal 208g, and a drain terminal 208d. The gate terminal 208g of the pullup transistor 208 is electrically connected to a pullup transistor enable voltage 230. The source terminal 208s of the pullup transistor 208 is electrically connected to the dynamic output bias signal 110. Further, the drain terminal 208d of the pullup transistor 208 is electrically connected to the second terminal 206b of the capacitor 206 and to the output signal circuitry 104. In an instance in which the pullup transistor 208 is enabled based on the pullup transistor enable voltage 230 the dynamic output bias signal 110 is transmitted to the output signal circuitry 104. The example pullup transistor 208 depicted in FIG. 3 is an n-channel metal-oxide semiconductor (NMOS) transistor.

As further depicted in FIG. 3, the output signal circuitry 104 includes a first inverter 232 (e.g., front inverter) connected in series with a second inverter 234 (e.g., back inverter). The output signal circuitry 104 is configured to receive the photon detection signal 108 and the dynamic output bias signal 110 at the first inverter 232 and output the photon detection output signal 112 at the second inverter 234.

The first inverter 232 includes a first front inverter transistor 210 and a second front inverter transistor 312. The first front inverter transistor 210 is a PMOS transistor with a source terminal 210s electrically connected to the source voltage 119. The second front inverter transistor 312 is a diode connected PMOS transistor in which the source terminal 312s electrically connected to the electrical ground 226 and the gate terminal 312g. The gate terminal 210g of the first front inverter transistor 210 is electrically connected to the second terminal 206b of the capacitor 206 and the drain terminal 208d of the pullup transistor 208 and configured to receive the photon detection signal 108 and the dynamic output bias signal 110. The drain terminals 210d, 312d of both transistors 210, 312 are electrically connected to generate the first inverter output 228.

The second inverter 234 includes a first back inverter transistor 214 and a second back inverter transistor 216 connected in a standard inverter configuration. The first back inverter transistor 214 is a PMOS transistor with a source terminal 214s electrically connected to the source voltage 119. The second back inverter transistor 216 is an NMOS transistor with a source terminal 216s electrically connected to the electrical ground 226. The gate terminals 214g, 216g of both transistors 214, 216 are electrically connected to the drain terminals 210d, 212d of the front inverter transistors, and configured to receive the first inverter output 228. The drain terminals 214d, 216d of both transistors 214, 216 are electrically connected to generate the photon detection output signal 112.

By configuring the second front inverter transistor 312 in a diode configuration, both the first front inverter transistor 210 and the second front inverter transistor 212 may comprise PMOS transistors. With each transistor comprising the same gate technology, the size of the output signal circuitry 104 and the overall size of the photon detection circuit 300 may be reduced.

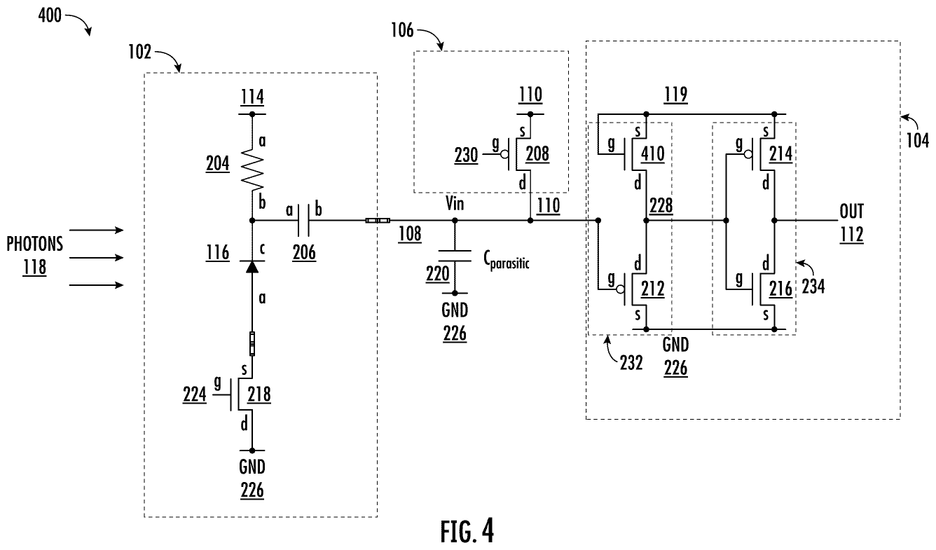

Referring now to FIG. 4, an example photon detection circuit 300 in accordance with the present disclosure, is provided. As depicted in FIG. 4, the example photon detection circuit 300 includes output signal circuitry 104 electrically connected to SPAD circuitry 102 and further configured to receive a dynamic output bias signal 110 from output bias circuitry 106.

As further depicted in FIG. 4, the SPAD circuitry 102 includes a SPAD 116 having a cathode terminal 116c and an anode terminal 116a; a quenching resistor 204 having a first terminal 204a and a second terminal 204b; a capacitor 206 having a first terminal 206a and a second terminal 206b; and a transistor 218 having a source terminal 218s, a gate terminal 218g, and a drain terminal 218d. As depicted in FIG. 4, the cathode terminal 116c of the SPAD 116 is electrically connected to the second terminal 204b of the quenching resistor 204 and the first terminal 206a of the capacitor 206. In addition, the anode terminal 116a of the SPAD 116 is electrically connected to the source terminal 218s of the transistor 218. The gate terminal 218g of the transistor 218 is further connected to a SPAD enable voltage 224 with the drain terminal 218d electrically connected to an electrical ground 226. The first terminal 204a of the quenching resistor 204 is electrically connected to the SPAD bias voltage 114. Further, the second terminal 206b of the capacitor 206 is electrically connected to the output signal circuitry 104, and the electrical signal at the second terminal 206b of the capacitor 206 is the photon detection signal 108. As depicted in FIG. 4, the example transistor 218 is a p-channel metal-oxide semiconductor (PMOS) transistor.

As further depicted in FIG. 4, a parasitic capacitance 220 is generated between the second terminal 206b of the capacitor 206 and the electrical ground 226.

As further depicted in FIG. 4, the example output bias circuitry 106 includes a pullup transistor 208 comprising a source terminal 208s, a gate terminal 208g, and a drain terminal 208d. The gate terminal 208g of the pullup transistor 208 is electrically connected to a pullup transistor enable voltage 230. The source terminal 208s of the pullup transistor 208 is electrically connected to the dynamic output bias signal 110. Further, the drain terminal 208d of the pullup transistor 208 is electrically connected to the second terminal 206b of the capacitor 206 and to the output signal circuitry 104. In an instance in which the pullup transistor 208 is enabled based on the pullup transistor enable voltage 230 the dynamic output bias signal 110 is transmitted to the output signal circuitry 104. The example pullup transistor 208 depicted in FIG. 4 is an n-channel metal-oxide semiconductor (NMOS) transistor.

As further depicted in FIG. 4, the output signal circuitry 104 includes a first inverter 232 (e.g., front inverter) connected in series with a second inverter 234 (e.g., back inverter). The output signal circuitry 104 is configured to receive the photon detection signal 108 and the dynamic output bias signal 110 at the first inverter 232 and output the photon detection output signal 112 at the second inverter 234.

The first inverter 232 includes a first front inverter transistor 410 and a second front inverter transistor 212. The first front inverter transistor 410 is a diode connected NMOS transistor in which the source terminal 410s electrically connected to the source voltage 119 and the gate terminal 410g. The gate terminal 212g of the second front inverter transistor 212 is electrically connected to the second terminal 206b of the capacitor 206 and the drain terminal 208d of the pullup transistor 208 and configured to receive the photon detection signal 108 and the dynamic output bias signal 110. The second front inverter transistor 212 is an NMOS transistor with a source terminal 212s electrically connected to the electrical ground 226. The drain terminals 410d, 212d of both transistors 410, 212 are electrically connected to generate the first inverter output 228.

The second inverter 234 includes a first back inverter transistor 214 and a second back inverter transistor 216 connected in a standard inverter configuration. The first back inverter transistor 214 is a PMOS transistor with a source terminal 214s electrically connected to the source voltage 119. The second back inverter transistor 216 is an NMOS transistor with a source terminal 216s electrically connected to the electrical ground 226. The gate terminals 214g, 216g of both transistors 214, 216 are electrically connected to the drain terminals 210d, 212d of the front inverter transistors, and configured to receive the first inverter output 228. The drain terminals 214d, 216d of both transistors 214, 216 are electrically connected to generate the photon detection output signal 112.

By configuring the first front inverter transistor 410 in a diode configuration, both the first front inverter transistor 410 and the second front inverter transistor 212 may comprise NMOS transistors. With each transistor comprising the same gate technology, the size of the output signal circuitry 104 and the overall size of the photon detection circuit 300 may be reduced.

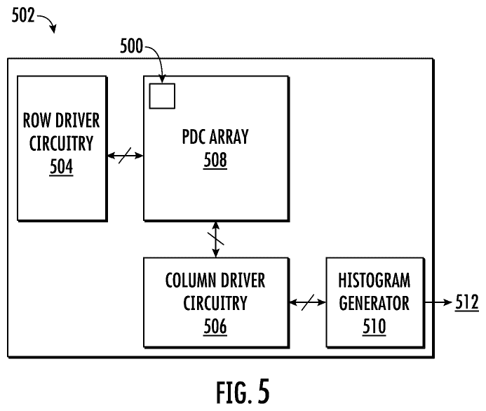

Referring now to FIG. 5, an example SPAD sensing device 502 comprising a plurality of photon detection circuits 500 configured in a photon detection circuit array 508 is provided. As depicted in FIG. 5, the example SPAD sensing device 502 further includes row driver circuitry 504 and column driver circuitry 506 electrically connected to the plurality of photon detection circuits 500 of the photon detection circuit array 508. The output of the row driver circuitry 504 and the column driver circuitry 506 are transmitted to a histogram generator 510 configured to generate an image histogram 512.

As depicted in FIG. 5, the example SPAD sensing device 502 includes a photon detection circuit array 508. A photon detection circuit array 508 is any collection of one or more photon detection circuits 500 arranged in a pre-determined pattern and designed to capture detect variations in illumination level of an environment. In some embodiments, the photon detection circuit array 508 may comprise a plurality of photon detection circuits 500 arranged in a two-dimensional shape, such as a square, rectangle, or circle. For example, a photon detection circuit array 508 may comprise a plurality of photon detection circuits 500 arranged in a rectangle comprising rows and columns. The SPAD sensing device 502 may include lenses and/or other optical devices to focus the light from an environment on to the photon detection circuit array 508, such that an image histogram 612 of the environment may be created.

As further depicted in FIG. 5, the example SPAD sensing device 502 includes row driver circuitry 504 and column driver circuitry 506. The row driver circuitry 504 and column driver circuitry 506 is any circuitry including hardware and/or software configured to provide functionality related to the operation of the photon detection circuits 500 in the photon detection circuit array 508. For example, the row driver circuitry 504 and column driver circuitry 506 may periodically measure and read the photon detection output signal of each photon detection circuit 500 to determine the number of photons (e.g., illumination) encountering each photon detection circuit 500 during the time period. The row driver circuitry 504 and column driver circuitry 506 periodically transmit data related to the number of photons encountering each photon detection circuit 500 to the histogram generator 510.

As further depicted in FIG. 5, the SPAD sensing device 502 includes a histogram generator 510. The histogram generator 510 is any circuitry including hardware and/or software configured to generate an image histogram 512 representing the illumination of an environment for a pre-determined time. The image histogram 512 may include a two-dimensional array of data wherein each element in the two-dimensional array of data represents the number of photons received at a photon detection circuit 500 of the photon detection circuit array 508 during a given time period. The histogram generator 510 may be configured to average illumination values for a photon detection circuit 500 over a number of sequential photon detection circuit 500 measurements. The image histogram 512 represents the measured illumination levels at various positions of an environment and may be used to determine, location and distance of various objects in the environment.

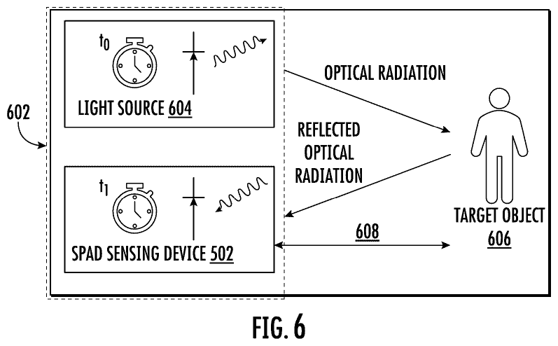

Referring now to FIG. 6, a direct time-of-flight detection system 602 utilizing a SPAD sensing device 502 is provided. A direct time-of-flight detection system 602 is any sensing device configured to transmit and receive electromagnetic waves (e.g., optical radiation) toward a target object 606 and determine spatial information and/or physical characteristics of the target object 606 based on the time-of-flight of the optical radiation to and from the direct time-of-flight detection system 602. In some embodiments, a direct time-of-flight detection system 602 may comprise a light detection and ranging (LiDAR)-based time-of-flight detection system.

As depicted in FIG. 6, the example direct time-of-flight detection system 602 includes a light source 604. A light source 604 is any device, bulb, semiconductor, diode, laser, or other photon-emitting structure configured to generate optical radiation and positioned to direct the optical radiation toward a target object 606. In some embodiments, a light source 604 may comprise a semiconductor laser diode, for example, a vertical cavity surface emitting laser (VCSEL) and/or an edge emitting laser diode. In general, a light source 604 may output a coherent light beam upon receipt of a current. In a direct time-of-flight detection system 602, the proximity 608 of target objects 606 in an environment may be measured by generating pulsed or continuous wave ranging optical radiation, receiving the reflected pulsed or continuous wave ranging optical radiation, and determining the time-of-flight of the pulsed or continuous wave ranging optical radiation. The proximity 608 of target objects 606 may include the distance of the target object 606 from the direct time-of-flight detection system 602, the position of the target object 606, the speed of the target object 606, the direction of motion of the target object 606, and other similar characteristics related to the position of the target object 606 in the environment.

A target object 606 may be any object, structure, person, entity, or other item positioned in the line-of-sight of the ranging optical radiation transmitted by the direct time-of-flight detection system 602. Determining the spatial and physical characteristics of one or more target objects 606 using a direct time-of-flight detection system 602 may include utilizing a SPAD sensing device 502. As described herein, a SPAD sensing device 502 is configured to detect and accurately time the arrival of the photons comprising the reflected ranging optical radiation. In some applications, the SPAD sensing device 502 may be deployed in environments that may include periods of high illumination, for example, outdoor applications. Utilizing the techniques described herein, such as dynamically adjusting the dynamic output bias signal 110 based on the number of photons received at the SPAD sensing device 502, may enable accurate detection of photons comprising the reflected ranging optical radiation even in high illumination environments.

As described in relation to FIG. 5, in some embodiments, the SPAD sensing device 502 may be configured to generate a image histogram (e.g., image histogram 512) or some other indicator of the positions of one or more target objects 606 in the observed environment. A processor or other connected device may utilize the image histogram to determine the physical and spatial characteristics of one or more target objects 606 in the observed environment.

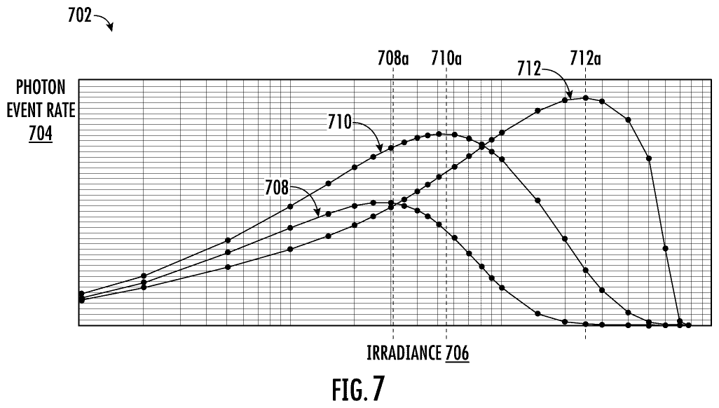

Referring now to FIG. 7, an example graph 702 depicting the photon event rate 704 of photon detection circuits of various sensitivities based on an irradiance 706 of an environment is provided.

As depicted in FIG. 7, the photon event rate 704 represents a number of photons detected at a photon detection circuit within a fixed time period. For example, the photon event rate 704 may be represented by the number of detected photons in a second.

As further depicted in FIG. 7, the irradiance 706 represents the radiant flux received by a surface per unit area. For example, irradiance 706 may be described in microwatts per centimeter-squared. As depicted in FIG. 7, the x-axis depicts an increasing irradiance 706 according to a logarithmic scale.

As illustrated by FIG. 7, each of the curves 708, 710, 712 represent the detected photon event rate 704. As the irradiance 706 at the photon detection circuit increases, the curves 708, 710, 712 initially increase. However, eventually, although the irradiance 706 continues to increase, the photon event rate for each of the curves 708, 710, 712 begins to slow, eventually reaching a point of full saturation 708a, 710a, 712a. Once the photon detection circuit 100 is fully saturated, the photon detection circuit 100 may enter a state of paralysis in which photons are no longer detected. As described herein, paralysis occurs in an instance in which the SPAD 116 is receiving photons so quickly, and avalanching so frequently, that the SPAD 116 is unable to recharge to the SPAD bias voltage 114. Thus, the photon detection signal 108 is insufficient to exceed the output signal circuitry threshold of the output signal circuitry 104 and no photon detection output signal 112 is generated.

As further depicted in FIG. 7, each curve 708, 710, 712 represents a different sensitivity mode of a photon detection circuit 100. For example, the curve 708 depicts an example photon event rate 704 with respect to irradiance 706 of a photon detection circuit at a standard sensitivity mode. The curve 710 depicts an example photon event rate 704 with respect to irradiance 706 of a photon detection circuit configured in a high sensitivity mode. The curve 712 depicts an example photon event rate 704 with respect to irradiance 706 of a photon detection circuit configured in a low sensitivity mode.

As described herein, the dynamic output bias signal 110 may be adjusted to update the output signal circuitry threshold and therefore the sensitivity of the photon detection circuit 100. For example, during low and/or normal illumination conditions, the dynamic output bias signal 110 may be adjusted to configure the photon detection circuit 100 for operation in a high sensitivity mode. As depicted in FIG. 7, the curve 710 depicts the response of a photon detection circuit 100 operating in high sensitivity mode. As further depicted in FIG. 7, the curve 710 begins to saturate at or near the point of full saturation 710a. Approaching saturation, the photon count may become inaccurate. Thus, the dynamic output bias signal 110 may be adjusted to configure the photon detection circuit 100 for operation in a low sensitivity mode. As depicted in FIG. 7, the curve 712 depicts the response of a photon detection circuit 100 operating in low sensitivity mode. At a low sensitivity mode, the photon detection circuit continues to provide linear response to the increase in irradiance 706 at much higher illumination values compared to the photon detection circuit 100 operating in high sensitivity mode.

As illustrated by the graph 702 of FIG. 7, the onset of saturation of a photon detection circuit may be determined by a variety of methods. For example, the change in photon event rate 704 may be monitored. A decline in changing photon event rate 704 with an increase in irradiance 706 may be an indication that the photon detection circuit 100 is nearing saturation and the dynamic output bias signal 110 may be adjusted. In some embodiments, the irradiance 706 at the photon detection circuit 100 may be measured by a separate system and the dynamic output bias signal 110 may be adjusted based on the determined irradiance 706. Still other methods based on the photon event rate, change in photon event rate, irradiance, and so on may be utilized to determine the saturation level of a photon detection circuit and update of the dynamic output bias signal 110.

As further described herein, in some embodiments, the dynamic output bias signal 110 may be incrementally adjusted between a high sensitivity mode and a low sensitivity mode based on the photon event rate detected at or near the photon detection circuit 100.

While this detailed description has set forth some embodiments of the present invention, the appended claims cover other embodiments of the present invention which differ from the described embodiments according to various modifications and improvements. For example, one skilled in the art may recognize that such principles may be applied to any sensing device utilizing time of flight of photons to determine physical characteristics of a target object. For example, LiDAR detection systems, proximity sensors, ranging sensors, 3-D object detection, velocity sensors, aerial detection systems, automated inspection devices, surveying and mapping, robotics, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A photon detection circuit comprising:
single photon avalanche diode (SPAD) circuitry configured to receive a SPAD bias voltage and generate a photon detection signal correlated with a number of photons encountering a SPAD and the SPAD bias voltage;
output bias circuitry configured to generate a dynamic output bias signal,
wherein the dynamic output bias signal is updated based on the number of photons encountering the SPAD; and
output signal circuitry configured to generate a photon detection output signal in an instance in which the photon detection signal exceeds an output signal circuitry threshold,
wherein the output signal circuitry threshold is based on the dynamic output bias signal.

2. The photon detection circuit of claim 1, wherein a saturation of the SPAD is determined based on a photon event rate, and wherein the photon event rate corresponds to a number of photons encountering the SPAD in a time period.

3. The photon detection circuit of claim 2, wherein the dynamic output bias signal is reduced in an instance in which the saturation of the SPAD increases.

4. The photon detection circuit of claim 2, wherein the dynamic output bias signal is increased in an instance in which the saturation of the SPAD decreases.

5. The photon detection circuit of claim 2, wherein the SPAD bias voltage is adjusted based on the saturation of the SPAD.

6. The photon detection circuit of claim 5, wherein the SPAD bias voltage is shifted towards a breakdown voltage of the SPAD in an instance in which the saturation of the SPAD increases.

7. The photon detection circuit of claim 1, wherein the dynamic output bias signal is updated within a dynamic output bias signal range comprising a minimum dynamic output bias signal voltage equal to the output signal circuitry threshold, and a maximum dynamic output bias signal voltage equal to a source voltage of the photon detection circuit.

8. The photon detection circuit of claim 1, wherein the SPAD circuitry comprises:
a SPAD comprising an anode electrically connected to an electrical ground and a cathode;
a quenching resistor comprising a first resistor terminal electrically connected to the SPAD bias voltage and a second resistor terminal electrically connected to the cathode of the SPAD; and
a capacitor comprising a first capacitor terminal electrically connected to the cathode of the SPAD and a second capacitor terminal configured to generate the photon detection signal.

9. The photon detection circuit of claim 1, wherein the output bias circuitry comprises:
a pull-up transistor comprising:
a source terminal electrically connected to the dynamic output bias signal;
a drain terminal electrically connected to an input of the output signal circuitry; and
a gate terminal electrically connected to a dynamic bias enable voltage.

10. The photon detection circuit of claim 1, wherein the output signal circuitry comprises:
a first inverter; and
a second inverter;
wherein the output signal circuitry threshold is a threshold voltage of the first inverter.

11. The photon detection circuit of claim 10, the first inverter comprising a first front inverter transistor and a second front inverter transistor; and
the second inverter comprising a first back inverter transistor and a second back inverter transistor.

12. The photon detection circuit of claim 11, wherein the first front inverter transistor and the second front inverter transistor are double gate oxide devices.

13. The photon detection circuit of claim 11, wherein the first back inverter transistor and the second back inverter transistor are single gate oxide devices.

14. The photon detection circuit of claim 11, wherein the first front inverter transistor is a PMOS transistor, and wherein the second front inverter transistor is a diode connected PMOS transistor.

15. The photon detection circuit of claim 11, wherein the second front inverter transistor is an NMOS transistor, and wherein the first front inverter transistor is a diode connected NMOS transistor.

16. The photon detection circuit of claim 1, further comprising:
a first layer comprising a top surface exposed to an external environment; and
a second layer adjacent a bottom surface of the first layer, opposite the top surface;
wherein the SPAD circuitry is disposed on the first layer of the photon detection circuit, and
wherein the output bias circuitry and output signal circuitry are disposed on the second layer of the photon detection circuitry.

17. A SPAD sensing device configured to generate an image histogram, the SPAD sensing device comprising:
a SPAD pixel array comprising a plurality of photon detection circuits arranged in a two-dimensional shape comprising rows and columns, each photon detection circuit comprising:
single photon avalanche diode (SPAD) circuitry configured to receive a SPAD bias voltage and generate a photon detection signal correlated with a number of photons encountering a SPAD and the SPAD bias voltage;
output bias circuitry configured to generate a dynamic output bias signal,
wherein the dynamic output bias signal is updated based on the number of photons encountering the SPAD; and
output signal circuitry configured to generate a photon detection output signal in an instance in which the photon detection signal exceeds an output signal circuitry threshold,
wherein the output signal circuitry threshold is based on the dynamic output bias signal.

18. The SPAD sensing device of claim 17, wherein a saturation of the SPAD is determined based on a photon event rate, wherein the photon event rate corresponds to a number of photons encountering the SPAD in a time period, and wherein the dynamic output bias signal is adjusted based on the saturation of the SPAD.

19. A direct time-of-flight detection system comprising:
a light source configured to transmit optical radiation directed at a target object; and
a SPAD sensing device configured to receive reflected optical radiation reflected off the target object, the SPAD sensing device comprising:
a SPAD pixel array comprising a plurality of photon detection circuits arranged in a two-dimensional shape comprising rows and columns, each photon detection circuit comprising:
single photon avalanche diode (SPAD) circuitry configured to receive a SPAD bias voltage and generate a photon detection signal correlated with a number of photons encountering a SPAD and the SPAD bias voltage;
output bias circuitry configured to generate a dynamic output bias signal,
wherein the dynamic output bias signal is updated based on the number of photons encountering the SPAD; and
output signal circuitry configured to generate a photon detection output signal in an instance in which the photon detection signal exceeds an output signal circuitry threshold,
wherein the output signal circuitry threshold is based on the dynamic output bias signal.

20. The direct time of flight system of claim 19, wherein a saturation of the SPAD is determined based on a photon event rate, wherein the photon event rate corresponds to a number of photons encountering the SPAD in a time period, and wherein the dynamic output bias signal is adjusted based on the saturation of the SPAD.
